(19) United States
(12) Patent Application Publication
(10) Pub. No.: US 2026/0297959 A1
(43) Pub. Date: Oct. 1, 2026

(54) SURFACE COVERING PANEL WITH TRANSITIONAL EDGE

(71) Applicant: Tarkett GDL, Lentzweiler (LU)

(72) Inventors: Christos MANTZARIDIS, Lentzweiler (LU); Jean-François BODY, Lentzweiler (LU)

(73) Assignee: Tarkett GDL, Lentzweiler (LU)

(21) Appl. No.: 19/488,984

(22) PCT Filed: Jun. 6, 2024
(86) PCT No.: PCT/EP2024/065591

§ 371 Date: Dec. 1, 2025

(30) Foreign Application Priority Data
Jun. 15, 2023 (LU) LU504519

(51) Int. Cl. E04F 15/10; B32B 3/30; B32B 27/40

(52) U.S. Cl. CPC E04F 15/107; B32B 3/30; B32B 27/40; B32B 2255/10; B32B 2305/72; B32B 2471/00

(57) ABSTRACT

A decorative surface covering panel comprises one or more core layers, a décor layer supported by the one or more core layers, and a transparent or translucent surface layer stack covering the décor layer. The stack comprises at least two compact crosslinked-polymer layers, the foremost of which provides the front surface. Each one of the one or more side surfaces has a frontward and a rearward portion. The decorative surface covering panel has a transitional edge surface touching a side surface along a boundary line located in the frontward portion thereof. The foremost and at least one further crosslinked-polymer layer of the surface layer stack extend to that frontward portion. The at least one further crosslinked-polymer layer has a topography including a shoulder section defining the angle of inclination of the transitional edge surface. The foremost crosslinked-polymer layer forms a topcoat conformally covering the topography including the shoulder section.

### BACKGROUND OF THE DISCLOSURE

The disclosure generally relates to the field of finishing materials for constructions, in particular to decorative surface coverings such as, for instance, floorings, wallcoverings or ceiling coverings. The disclosure more specifically concerns a decorative surface covering panel, e.g., a flooring tile, a flooring plank, a wallcovering tile or a wallcovering plank and a method for producing the same.

Decorative surface coverings such as flooring, wallcovering or ceiling covering, may be of the so-called homogeneous or heterogeneous types. A homogeneous surface covering has essentially the same composition throughout its thickness (except, maybe, for a topcoat and/or a textile backing), whereas a heterogeneous surface covering comprises a stack of layers which differ in their functions and compositions. A typical layer structure of a heterogeneous surface covering comprises a backing layer, one or more core layers, a décor layer, a protective wear layer and a topcoat. The décor layer may be a thin layer of a natural material, e.g., cork or wood, but may also comprise a printed décor, imitating or not a natural material.

Decorative surface covering panels are often provided with chamfers, or bevels along their visible edges, sometimes with fillets. Bevels or fillets may help to conceal slight height differences between neighbouring panels, e.g., due to subfloor imperfections, and make the panel edges more robust against wear. Whereas bevelled edges can be easily provided on wood panels, the task may be more difficult especially on heterogeneous surface coverings comprising different layers. Obliquely cutting the edges of the panels may indeed reveal the interior structure of the panels and expose it to wear. Various methods have been proposed to redecorate the bevel surface and to protect it.

U.S. Pat. No. 7,918,062 B2 relates to laminated floor panel having at least one bevel. Specifically, the document discloses a floor panel comprising a core, a bevel with a bevel surface, a décor pattern on the core except on the bevel surface and a non-transfer printed decorative pattern on the bevel surface.

WO 2007/054812 A2 relates to hard floor panels having a bevelled edge, wherein the surfaces of the bevelled edges are provided, at least partially, with a separately applied decorative covering.

WO 2007/146117 A2 discloses methods and systems for decorating a bevel surface of a laminated flooring. The bevel surface can be decorated by non-transfer printing such as digital printing. The digital printer can be an ink jet printer such as a piezoelectric drop-on-demand (DOD) printer that allows a colour and pattern to be placed on the bevel surface that matches the print design (decor pattern or face design) of the laminated flooring.

In order to improve the realism of a printed décor imitating a natural material, such as wood, cork, stone, etc., the surface covering may be given a surface structure by embossing. Mechanical embossing involves pressing an embossing plate or cylinder against the surface covering under high temperature so as to transfer the three-dimensional pattern of the embossing plate or cylinder into the surface covering. In high-quality surface coverings, the embossing is carried out in register with the printed décor.

WO 2017/046309 A1 discloses a base panel suitable to be processed into a covering panel, consisting of: (i) a substrate having a top surface, (ii) a resilient layer having a top surface and a bottom surface, the bottom surface being connected to the top surface of the substrate, and (iii) optionally, a contact layer between the bottom surface of the resilient layer and the top surface of the substrate. The covering panel comprises a digitally printed décor on the top surface of the resilient layer of the base panel. The covering panel may further be provided with an embossing pattern, which may be applied in register with the print, so as to accentuate the appearance of the décor.

Digitally printed décors are gaining in importance, in particular (but not only) due to the fact that designs can be changed more quickly and at much lower costs than with conventional printing techniques, such as, e.g. heliogravure printing. This allows the industry to react more flexibly to changing market demands and to reduce product development costs.

Likewise, digital embossing techniques have been developed to replace the conventional embossing cylinders.

US2020346246A1 relates to a method for manufacturing a structure on a surface of a workpiece. The method comprises the following steps: applying a liquid base layer onto the surface of the workpiece; jetting droplets into the not yet solidified base layer, wherein the droplets at least partially penetrate into the base layer; indurating the base layer; and removing the droplets.

EP3109056A1 discloses a method for producing a structure on a surface. A liquid layer is applied onto a workpiece. Subsequently, a manipulation medium in the form of droplets is sprayed onto the liquid layer, whereby a displacement of the liquid layer occurs by the droplets so that recesses together forming a structure in the liquid layer are formed therein. Subsequently, this layer is solidified.

US2020368777A1 discloses a method for producing a decorative surface on a workpiece. The method comprises: feeding of the workpiece coated with a liquid layer to a digital printing station; application of an agent capable of at least partially absorbing electromagnetic radiation, at least on a partial area of the surface of the liquid layer, or which, in contact with the surface, produces a reaction product which is capable of at least partially absorbing electromagnetic radiation; irradiation of the surface of the liquid layer and of the agent with electromagnetic radiation having a wavelength of less than 300 nm. Irradiation of the surface of the liquid layer causes polymerization of the liquid layer and leads to micro-folding, thereby forming a microstructure.

US2020346395A1 discloses a method for producing a decorative surface, wherein a manipulation medium (such as that of EP3109056A1 or the agent of US2020368777A1) to the surface is removed therefrom in a mechanical and/or contactless manner.

US2022355335A1 relates to manufacturing areas having different degrees of hardness in a base layer. The method comprises the steps: applying a mask (e.g., in the form of droplets) on a partial area of the surface of the base layer, the mask at least partially absorbing electromagnetic radiation; and irradiating the base layer and the applied mask with electromagnetic radiation, in particular with UV radiation and/or IR radiation, to set different degrees of hardness of the base layer. The mask and the areas of the base layer with a lower degree of hardness may be removed, e.g., physically and/or chemically, so as to create depressions or holes in the base layer.

WO 2010/070485 A2 relates to manufacturing coated panels comprising at least a substrate and a top layer with a motif. The method for manufacturing of the top layer comprises at least two steps, namely, a first step, in which a synthetic material layer is provided on the substrate, and a second, subsequent step, in which a relief is provided on the surface of the synthetic material layer. The relief comprises a pattern of recesses and/or projections, that is at least partially determined by one or more prints. The same printing technique may be applied both for forming the motif and for forming the one or more prints. For instance, a digital printing technique, such as inkjet printing, may be applied. The relief structure is formed by using an expansion-preventing or expansion-reducing agent. In spots where this agent is applied, the expansion of the synthetic material layer occurs to a lesser extent than elsewhere or not at all. The document discloses that this technique may be used, inter alia, to produce chamfers at the edges of the panel and recesses for imitating wood pores.

### SUMMARY

According to a first aspect of the disclosure, a decorative surface covering panel is proposed. The panel has a front surface, a rear surface and one or more side surfaces extending around the decorative surface covering panel. The panel furthermore has a layered structure comprising, in this order from the rear surface to the front surface: one or more core layers, a décor layer supported by the one or more core layers, and a transparent or translucent surface layer stack covering the décor layer. The surface layer stack comprises at least two compact (unfoamed) crosslinked-polymer layers, the foremost of which provides the front surface. Each one of the one or more side surfaces has a frontward portion and a rearward portion separated from each other at the height of the décor layer (by the décor layer). The frontward portion is closer to the front surface and the rearward portion is farther away from the front surface, i.e., the frontward portion corresponds to the portion of the side surface that extends from the décor layer towards the front surface whereas the rearward portion corresponds to the portion of the side surface that extends from the décor layer towards the rear surface. The decorative surface covering panel has at least one transitional edge surface extending from the front surface to one of the one or more side surfaces. The at least one transitional edge surface touches the one of the one or more side surfaces along a boundary line recessed from the front surface, the boundary line being located in the frontward portion of the one of the one or more side surfaces. The foremost crosslinked-polymer layer and at least one further crosslinked-polymer layer of the surface layer stack extend to the frontward portion of the one of the one or more side surfaces, between the décor layer and the boundary line. The at least one further crosslinked-polymer layer of the surface layer stack that extends to the frontward portion of the one of the one or more side surfaces has a topography including a shoulder section underlying the at least one transitional edge surface and defining the profile of the transitional edge surface. The foremost crosslinked-polymer layer forms a topcoat on the at least one further crosslinked-polymer layer conformally covering the topography of the at least one further crosslinked-polymer layer including the ramp section thereof, i.e., the foremost crosslinked-polymer layer forms a film on the at least one further crosslinked-polymer layer that follows the contours thereof.

As used herein, the expression “crosslinked polymer” designates a polymer obtained by irreversibly hardening (curing) a prepolymer resin. The crosslinked-polymer layers may comprise polyurethane, epoxy, polyurea, polyester, etc. as the polymer matrix. They may comprise additional ingredients, such as, e.g., fillers, pigments and additives. In the present context, the layers of the transparent or translucent surface layer stack are compact, i.e., not foamed.

The expression “crosslinkable” herein refers to the capacity of a (liquid or viscous) resin composition containing unpolymerized or partially polymerized reagents (prepolymer resin) to undergo a curing process, including one or more chemical reactions, that forms covalent bonds (in particular, crosslinks) between polymer chains, and thereby transforms the resin composition into a solid (layer) having a three-dimensional polymeric network. Curing can be induced by heat (in the case of thermoset resins), radiation (including electromagnetic radiation, such as e.g., UV light, and particle radiation, in particular, electron radiation), and/or chemical additives (e.g., hardeners). Examples of crosslinkable resin compositions include urethane acrylate, polyurethane acrylate, epoxy acrylate, polyester acrylate, polyether acrylate and/or polyether urethane acrylate. Preferably, the foremost crosslinked-polymer layer is made from polyurethane, e.g., polyurethane acrylate or polyether urethane acrylate. The at least one further crosslinked-polymer layer of the surface layer stack may also be made from polyurethane acrylate or polyether urethane acrylate.

The expression “topography” designates the forms and features of a surface, in particular, the deviations from a perfectly flat surface, like depressions (valleys, holes, grooves, dimples, etc.) or protruding features (peaks, ridges, humps, ribs, etc.) The topography may be imparted by embossing, in particular by digital embossing. It will be understood that the scale of the topographic features is greater than the scale of the material-intrinsic surface texture (surface roughness, waviness, porosity). The topography of the at least one further crosslinked-polymer layer preferably includes, in addition to the ramp section, depressions and/or protrusions in register with the decorative motif of the décor layer.

The expressions “décor” and “decorative” are used herein to indicate that the corresponding item, layer or surface remains visible in the final product when in use as intended and contributes to the outer appearance of the surface covering. The decorative motif (or two-dimensional décor) is, preferably, at least one-dimensionally patterned, “at least one-dimensionally patterned” meaning that there are colour or shade variations (preferably including plural gradients and/or steps) of the decorative motif along at least one direction, the variation being noticeable to the naked human eye. The decorative motif may have such variations in two mutually perpendicular directions.

The shoulder section may be rounded (so as to form a convex fillet) or sloping (so as to form a ramp). The shoulder section may comprise one or more steps (optionally with a concave fillet where the step surfaces meet). When the shoulder section is a ramp, the transitional edge may be termed “bevelled edge”.

The decorative surface covering panel may have plural side surfaces and plural transitional edge surfaces, each transitional edge surface extending from the front surface to a respective one of the side surfaces. Each transitional edge surface may touch the respective side surface along a boundary line recessed from the front surface, the boundary line being located in the frontward portion of the respective side surface. The foremost crosslinked-polymer layer and at least one further crosslinked-polymer layer of the surface layer stack may extend to the frontward portion of each one of the side surfaces, between the décor layer and the boundary line. The topography of the at least one further crosslinked-polymer layer of the surface layer stack may include plural ramp sections, each ramp section underlying a respective transitional edge surface and defining the angle of inclination of the respective transitional edge surface. The foremost crosslinked-polymer layer may conformally cover the topography of the at least one further crosslinked-polymer layer including the plural shoulder sections thereof.

The foremost crosslinked-polymer layer may have (substantially) uniform thickness all over the front surface and the transitional edge surface(s). The thickness of the foremost crosslinked-polymer layer is preferably substantially smaller (e.g., 30% or less, 25% or less, 20% or less, 15% or less, 10% or less) than the at least one further crosslinked-polymer layer of the surface layer stack. According to preferred embodiments of the decorative surface covering panel, the foremost crosslinked-polymer layer has a thickness that amounts to 15% or less, preferably to 10% or less than, of the overall thickness of the at least one further crosslinked-polymer layer of the surface layer stack. The foremost crosslinked-polymer layer may, preferably, comprise a microfolded skin layer, obtained by exposing the UV-curable foremost layer to V-UV light first so as to cure it at the surface only and then curing the foremost layer in depth, this leading to shrinkage and to microfolding of the skin layer.

The décor layer may comprise a digitally printed two-dimensional decorative motif. The topography of the at least one further crosslinked-polymer layer may be in register with the decorative motif. As used herein, “digital printing” means a digitally (computer-) controlled deposition and immobilization of material (e.g., pigment or dye ink, water or solvent based) in pre-defined patterns onto a surface, the pre-defined patterns being derived from digital data, e.g., in the form of an image file, provided to the digital printing equipment. A digitally printed motif or layer is the result of digital printing. Examples of digital printing include inkjet printing or laser printing. “Digital 3D printing” refers to such a process, wherein the deposited material is solidified to create a three-dimensional pattern, which is raised or lowered with respect to the surface on which is printed.

The decorative surface covering panel may be configured for loose-lay installation. Alternatively, the decorative surface covering panel could be glued to its support, e.g., the subfloor or the wall. The surfaces of the decorative surface covering panel may comprise connection (locking) profiles, e.g., tongue and groove connectors or interdigitating elements.

The decorative surface covering panel may comprise additional layers not specifically mentioned above. For instance, it may comprise one or more reinforcing layers, such as, e.g., a fibre veil, a glass veil, a fibre mesh, etc. The decorative surface covering panel may also comprise a backing layer on the rear surface, e.g., a fibre backing, a foam underlay and/or an acoustic foam.

A further aspect of the disclosure relates to a method for producing a decorative surface covering panel, in particular a decorative surface covering panel as described above and/or claimed hereinafter. The method comprises: providing a substructure comprising one or more core layers and a décor layer supported by the one or more core layers, and forming, on the décor layer, a transparent or translucent surface layer stack comprised of at least two crosslinked-polymer layers. The forming of the surface layer stack comprises applying, on the décor layer, one or more intermediate layers of one or more crosslinkable resin compositions, and, on the one or more intermediate layers, a foremost layer of a crosslinkable resin composition. Before applying the foremost layer, a three-dimensional surface topography is generated by digitally embossing at least one of the one or more intermediate layers, the digital embossing comprising at least partially curing the crosslinkable resin composition of the one or more intermediate layers, the three-dimensional surface topography including a shoulder section extending along an edge of the surface covering panel. The foremost layer is applied as a topcoat conformally covering the topography of the intermediate layers including the shoulder section thereof.

The expression “digital embossing” herein designates a technique to a impart a three-dimensional topography to a surface in accordance with digital data, e.g., in the form of a relief file, provided to the digital embossing equipment. Various digital embossing techniques may be envisaged in the context of the disclosure. The embossing depth, i.e., the (maximum) amplitude of the thickness variations of the layer wherein the topography is realized, preferably ranges from 50 μm to 300 μm, more preferably from 50 μm to 200 μm, but greater embossing depths are possible, e.g. from 50 μm to 500 μm or even more.

The substructure may have the lateral dimensions (e.g., length and width) of the decorative surface covering panel. Alternatively, the substructure may be provided as a blank or as a continuous web which may be cut into one or more panels after application of (at least part of) the surface layer stack. The substructure may thus have at least one lateral dimension greater than the decorative surface covering panel. In this case, the method may comprise cutting the substructure in register with the topography of the intermediate layers, along the shoulder section, after embossing the at least one of the one or more intermediate layers. The cutting may be carried out before or after application of the foremost layer of the surface layer stack.

The décor layer may comprise a printed two-dimensional decorative motif (preferably a digitally printed two-dimensional decorative motif), and the digital embossing may be carried out in register with the decorative motif.

The step of providing the substructure may comprise digitally printing the decorative motif directly on one of the one or more core layers or on a separate printing substrate, e.g., a primer layer, that is placed on the one or more core layers.

The digital embossing may comprise digitally printing a pattern (“mask pattern”) of a crosslinking blocking agent and/or repelling agent onto the crosslinkable resin composition of the one or more intermediate layers, (at least partially) curing the crosslinkable resin composition with the pattern in place, and removing the at least one of the crosslinking blocking agent and/or repelling agent and, possibly, uncured crosslinkable resin composition. The crosslinking blocking agent may comprise crosslinking inhibitors and/or one or more photoprotective agents, e.g., mineral and/or chemical UV filters. The mask pattern may be a binary mask pattern or comprise gradients or graduations of the areal density of crosslinking blocking agent. The mask pattern may also comprise one or more crosslinking blocking agents in combination with one or more repelling agents. If the mask pattern comprises plural components, e.g., plural crosslinking blocking agents, plural repelling agents, or one or more crosslinking blocking agents in combination with one or more repelling agents, these may be applied via separate printheads, so that the areal densities of the different components may be varied relative to one another within the mask pattern. A decorative surface covering panel according to the first aspect of the disclosure may, preferably, be obtained by the method using crosslinking blocking agent and/or repelling agent. Such a decorative surface covering panel may, therefore, have residues of crosslinking blocking agent and/or repelling agent embedded in the transparent or translucent surface layer stack, in particular in or on the at least one further crosslinked-polymer layer but beneath the foremost crosslinked-polymer layer.

Mineral UV filters may include UV-blocking pigments, such as, e.g., ultrafine titanium dioxide and/or ultrafine zinc oxide. Chemical UV filters may include (2-hydroxy-4-methoxyphenyl)(phenyl)methanone, 3,3,5-trimethylcyclohexyl 2-hydroxybenzoate, 2-ethylhexyl 2-cyano-3,3-diphenylprop-2-enoate, 2-ethoxyethyl (2E)-3-(4-methoxyphenyl)prop-2-enoate, 3-methylbutyl (2E)-3-(4-methoxyphenyl)prop-2-enoate, etc.

The one or more crosslinking inhibitors may comprise, e.g., a phenotiazine, a hydroquinone and/or an itaconate.

The repelling agent may comprise solid particles, a liquid or a gel, displacing crosslinkable resin composition out of the areas where the repelling agent is applied. Upon (partial) curing, the repelling agent may be removed, leaving depressions in the (partially) crosslinked polymer.

The removal of the crosslinking blocking agent and/or repelling agent and, possibly, uncured crosslinkable resin composition may be effected by mechanical action, e.g., by blowing, brushing, and/or aspiration. The removal could, e.g., be carried out using one or more brushes which loosen the pattern of crosslinking blocking agent and/or repelling agent and uncured resin residues by mechanical friction and one or more suction apparatuses. Additionally or alternatively, an air-knife could be used.

The crosslinkable resin composition may be a radiation-curable resin composition, e.g., a UV-curable resin composition or an electron-beam-curable resin composition. The radiation-curable crosslinkable resin composition may, e.g., comprise urethane acrylate, acrylated epoxy, polyester acrylate, polyether acrylate and/or polyether urethane acrylate.

The at least partial curing of the crosslinkable resin composition(s) may be effected with UV light. UV light may be produced with a mercury lamp, a gallium lamp, a UV-LED, and/or an excimer lamp.

The foremost layer may be UV-curable. Applying the foremost layer may comprise generating a microfolded skin layer in the foremost layer by exposing the UV-curable foremost layer to V-UV light and then curing the foremost layer in depth.

The one or more core layers and/or the décor layer may be PVC-based. Alternatively, the one or more core layers and/or the décor layer may be substantially PVC-free. As used herein, the expression “PVC-free” qualifies an entity (e.g., a composition) containing less than 0.01% by weight of polyvinyl chloride (PVC). The decorative surface covering panel may be PVC-free as a whole.

The surface layer stack may be applied in direct contact with the printed decorative motif, i.e., the decorative surface covering in that case comprises no intermediate layer between the printed decorative motif and the surface layer stack, such as e.g., a PVC-based wear layer. The surface layer stack may comprise, as its rearmost layer, a compatibilizing layer (also: primer layer), which provides adhesion between the décor layer and the further layers of the surface layer stack.

The surface layer stack preferably comprises no intermediate alien layer, i.e., no intermediate layer that is formed neither of a crosslinkable resin composition nor of a crosslinked polymer layer.

In the present document, the verb “to comprise” and the expression “to be comprised of” are used as open transitional phrases meaning “to include” or “to consist at least of”. Unless otherwise implied by context, the use of singular word form is intended to encompass the plural, except when the cardinal number “one” is used: “one” herein means “exactly one”. Ordinal numbers (“first”, “second”, etc.) are used herein to differentiate between different instances of a generic object; no particular order, importance or hierarchy is intended to be implied by the use of these expressions. Furthermore, when plural instances of an object are referred to by ordinal numbers, this does not necessarily mean that no other instances of that object are present (unless this follows clearly from context). When this description refers to “an embodiment”, “one embodiment”, “embodiments”, etc., this means that the features of those embodiments can be used in the combination explicitly presented but also that the features can be combined across embodiments without departing from the disclosure, unless it follows from context that features cannot be combined.

### BRIEF DESCRIPTION OF THE DRAWINGS

By way of example, preferred, non-limiting embodiments of the disclosure will now be described in detail with reference to the accompanying drawings, in which:

FIG. 1: is a schematic perspective illustration of a decorative surface covering panel according to a first preferred embodiment of the disclosure;

FIG. 2: is a schematic illustration of a manufacturing process of decorative surface covering panels;

FIG. 3: is a schematic illustration of a variant of the manufacturing process illustrated in FIG. 2;

FIG. 4: is a schematic cross section of a decorative surface covering panel with a transitional edge having the form of a convex rounded shoulder;

FIG. 5: is a schematic cross section of a decorative surface covering panel with a transitional edge having the form of a step-shaped shoulder;

FIG. 6: is a schematic cross section of a decorative surface covering panel with a transitional edge having the form of a concave rounded shoulder.

It should be noted that the drawings are strictly schematic and not to scale. This holds also for the inserts showing the cross-sections of the decorative surface covering in the making. In particular, it should be noted that these inserts do not necessarily show the thicknesses of the different layers in the actual proportions.

### DETAILED DESCRIPTION

It will be understood that the following description and the drawings to which it refers describe by way of example several embodiments of the proposed disclosure for illustration purposes. This description of preferred embodiments shall not limit the scope, nature or spirit of the claimed subject matter. The skilled person will appreciate that features of the different embodiments may be combined into further embodiments without departing from the scope of the present disclosure.

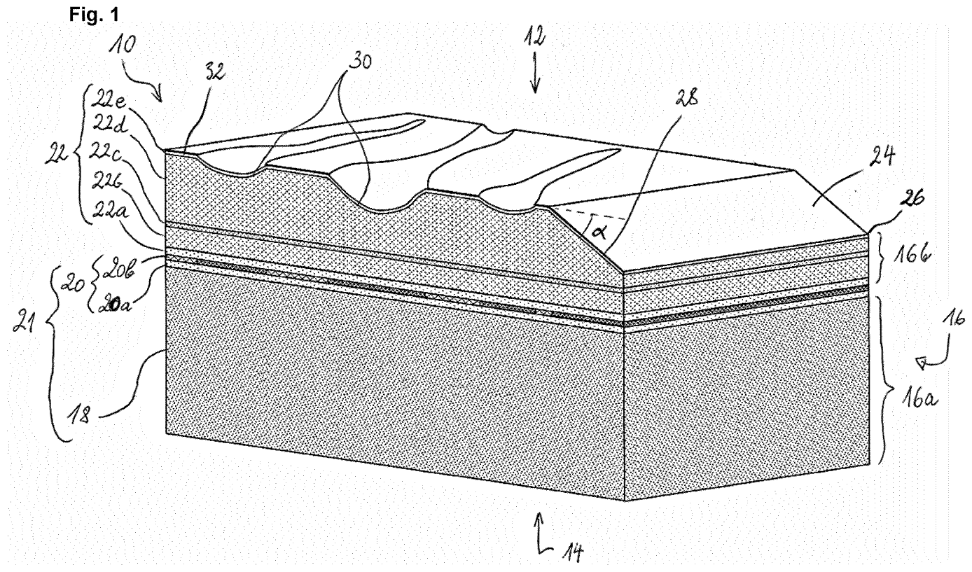

FIG. 1 illustrates a first embodiment of a decorative surface covering panel 10, e.g., a flooring tile or plank. The panel 10 may, e. g,, be obtained by a method as disclosed herein. The panel has a front surface 12, a rear surface 14 and a side surface 16. Side surface 16 typically belongs to a set of plural side surfaces extending around the panel 10. It should be noted that the side surfaces may comprise connection profiles, e.g., tongue and groove connectors, but these are not shown for the sake of clarity of the drawing.

The panel 10 has a layered structure comprising, in this order from the rear surface to the front surface: a core structure 18 comprising one or more core layers, a décor layer 20 supported by the core structure 18, and a transparent or translucent surface layer stack 22 covering the décor layer 20.

In the illustrated example, the décor layer 20 comprises a printing substrate 20a and a layer of ink 20b printed on the printing substrate 20a. The surface layer stack 22 comprises a first crosslinked-polymer layer 22a, which is selected to provide adhesion between the ink layer 20b and the surface layer stack 22. A second crosslinked-polymer layer 22b, e.g., a polyurethane layer, is provided on top of the first crosslinked-polymer layer 22a and provides the structural base of the surface layer stack 22. A third crosslinked-polymer layer 22c serves as a light diffusing layer 22c and is placed on the second crosslinked-polymer layer 22b to control the glossiness of the panel 10. A fourth crosslinked-polymer layer 22d is arranged on the light diffusing layer 22c. Finally, a fifth crosslinked-polymer layer 22e is arranged as a topcoat on the fourth crosslinked-polymer layer 22d and provides the front surface 12 of the panel 10. The substructure carrying the surface layer stack 22, including the core structure 18 and the décor layer 20, is designated by reference number 21.

The side surface can be divided at the height of the décor layer into a rearward portion 16a and a frontward portion 16b. The panel 10 has a transitional edge surface. In the embodiment illustrated in FIG. 1, the transitional edge surface comprises a bevelled edge surface 24 extending, at an angle of inclination α, from the front surface 12 to the side surface 16. The angle α may, e.g., lie in the range from 5° to 85°, preferably from 5° to 50°, more preferably in the range from 6° to 35° and still more preferably in the range from 7 to 25°. The bevelled edge surface 24 touches the side surface 16 along a boundary line 26 that is located, on its entire length, in the frontward portion 16b of the side surface 16.

As can be seen in FIG. 1, the foremost crosslinked-polymer layer 22e and the other crosslinked-polymer layers 22a, 22b, 22c, 22d of the surface layer stack 22 extend to the frontward portion 16b of the side surface 16.

The fourth crosslinked-polymer layer 22d has a surface topography including a shoulder section illustrated as a ramp section 28. In the illustrated embodiment, the topography further includes features such as depressions 30 and protrusions 32 arranged in register with corresponding features of the decorative motif of the décor layer 20. The ramp section 28 is located below the bevelled edge surface 24 and defines its angle of inclination α, since the foremost crosslinked-polymer layer 22e has (substantially) uniform thickness and conformally covers the topography of the fourth crosslinked-polymer layer, including the ramp section.

The crosslinked-polymer layers 22a, 22b, 22c, 22d, 22e are preferably polyurethane layers, (poly)urethane acrylate layers, epoxy acrylate layers, polyester acrylate layers, polyether acrylate layers and/or polyether urethane acrylate layers.

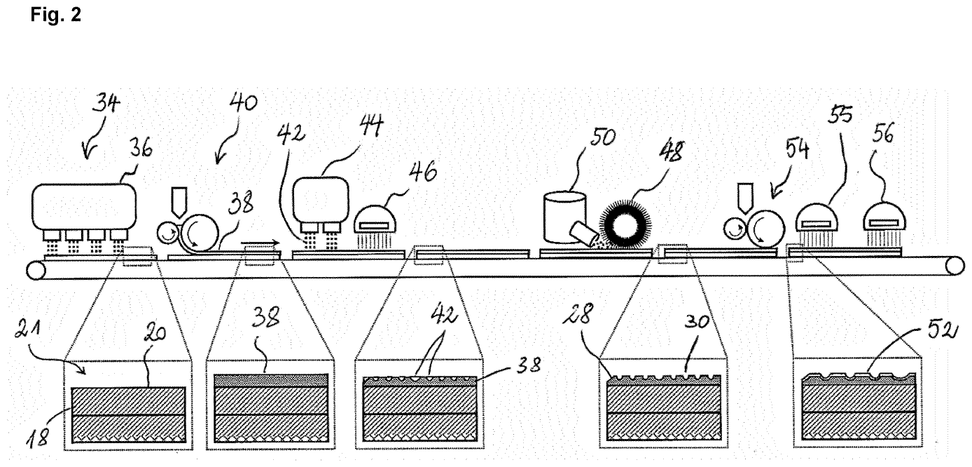

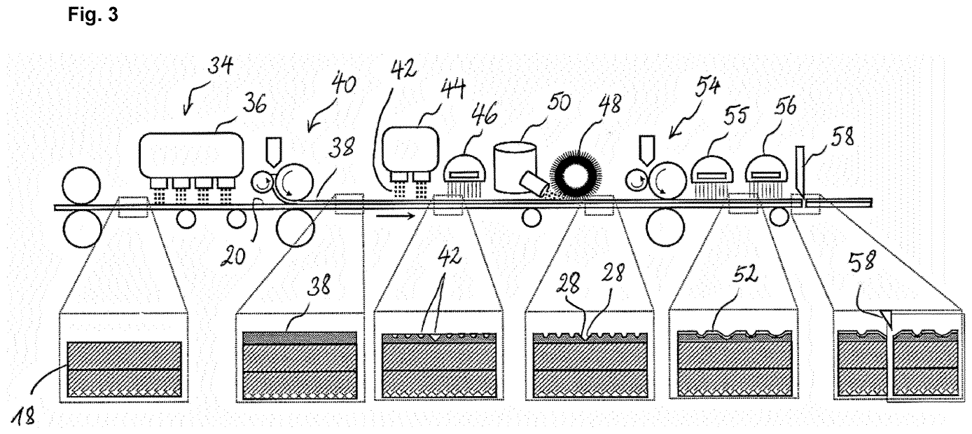

FIGS. 2 and 3 schematically illustrate a method for producing a decorative surface covering according to embodiments of the disclosure.

A core structure 18, optionally with one or more primer layers and/or one or more base coats thereon, is provided as a printing substrate in a digital printing stage 34.

The digital printing stage 34 may include one or more digital printers 36, e.g., a single-pass industrial printer. The digital printer 36 prints a two-dimensional decorative motif onto the core structure 18 so as to provide or complete the décor layer 20 thereon. The layer that receives the ink directly thereon may be referred to as the décor-carrying layer. (In the embodiment of FIG. 1 the printing substrate 20a would be considered as the décor-carrying layer.) The digital printer 36 may comprise printheads that project ink droplets onto the décor-carrying layer in a very precise manner, in terms of position and volume of the droplets. The digital printer 36 may comprise a single-pass industrial printer, which uses several printheads aligned side by side in several rows that cover the entire width of the multilayer surface covering substructure. Each row of printheads may print one or more colours. During the printing process, the surface covering substructure 21 advances in the machine direction under the printheads. The digital printer 36 may be custom-made for the application in accordance with the requirements in terms of capacity and print quality. The digital printer 36 could use thermal printhead technology, wherein a current pulse passing through a heating element vaporizes a tiny quantity of ink in a chamber so as to form a bubble, and this bubble propels an ink droplet through the printhead nozzle onto the printing substrate. Additionally, or alternatively, the digital printer 36 could also use piezoelectric printheads, wherein a piezoelectric element, on application of a voltage, generates a pressure pulse that drives an ink droplet through the nozzle. The ink is chosen in accordance with the printhead technology, the décor carrying layer, the subsequent processing steps as well as quality and price constraints.

Various types of ink could be used in implementations of the method. Inks typically comprise one or more colorants, a binder that bonds the colorants to the surface and a carrier liquid. Colorants comprise dyes or pigments or a combination of both. Pigments are solid colorant particles that are suspended or dispersed throughout the carrier liquid. Pigment-based inks may be more light-stable and more fade-resistant than dye-based inks. Furthermore, dye-based inks often comprise organic solvents which may lead to higher VOC emissions than pigment-based inks, especially when water is the carrier liquid of the latter. Carrier liquids may include solvents, oil(s), water and polymeric resins. For certain surface coverings, radiation-curable inks may be considered as particularly advantageous.

The digital printer 36 may include a drying or curing stage (not shown in FIGS. 2 and 3), wherein the printed decorative motif is solidified and bonded to the décor-carrying layer. Such drying or curing stage could comprise one or more heaters and/or one or more blowers and/or one or more radiation sources, depending on the type of ink used by the digital printer 36. Drying/curing prior to application of the layers of crosslinkable resin composition(s) may be particularly recommended if the ink includes non-reactive solvent(s) or carrier(s), which can no longer be efficiently eliminated or reacted after the printed decorative motif has become sandwiched between its substrate and the first layer of crosslinkable resin composition.

After application of the printed decorative motif, one or more layers of crosslinkable resin composition(s) are applied on the décor layer 20. To keep the drawing simple, application of only one layer of a crosslinkable resin composition 38 is shown at coating stage 40. If plural layers of crosslinkable resin composition(s) are applied, an intermediate (partial) curing operation may be carried out after application of each layer prior to application of the next layer.

The penultimate layer of the transparent or translucent surface layer stack is the layer to be digitally embossed. In FIGS. 2 and 3, this corresponds to layer 38. The crosslinkable resin composition layer 38 is subjected to a digitally embossing process during which a three-dimensional surface topography is generated in register with the printed decorative motif.

It will be understood that various digital embossing techniques may be contemplated. In the embodiment illustrated in FIGS. 2 and 3, the digital embossing-in-register comprises, as a first step, application of a “mask pattern” by digital printing, in register with the decorative motif, a crosslinking blocking agent 42. The mask pattern is applied by means of digital printer 44. In a further step, the layer of crosslinkable resin composition 38 carrying the mask pattern is at least partially cured, e.g., by one or more UV lamps 46. The crosslinking blocking agent 42 is selected such that it delays or prevents solidification of the crosslinkable resin composition 38 in the zones with The crosslinking blocking agent 42 may comprise one or more crosslinking inhibitors and/or one or more photoprotective agents, e.g., mineral and/or chemical UV filters. Mineral UV filters may include UV-blocking pigments, such as, e.g., ultrafine titanium dioxide and/or ultrafine zinc oxide. Chemical UV filters may include (2-hydroxy-4-methoxyphenyl)(phenyl)methanone, 3,3,5-trimethylcyclohexyl 2 -hydroxybenzoate, 2-ethylhexyl 2-cyano-3,3-diphenylprop-2-enoate, 2-ethoxyethyl (2E)-3-(4-methoxyphenyl)prop-2-enoate, 3-methylbutyl (2E)-3-(4-methoxyphenyl)prop-2-enoate, etc. The one or more crosslinking inhibitors may comprise, e.g., a phenotiazine, a hydroquinone and/or an itaconate.

The expression “mask pattern” does not necessarily mean that the crosslinking blocking agent 42 locally blocks or reduces the irradiance of the crosslinkable resin composition 38. The crosslinking blocking agent 42 may, additionally, or alternatively, comprise a crosslinking inhibitor so as to (locally) neutralize or deactivate any photoinitiator contained in the crosslinkable resin composition 38, and/or to block crosslinking sites of the reagents of the crosslinkable resin composition 38, and/or to otherwise (locally) impede the chemical reactions that lead to the formation of a polymeric network.

In embodiments, the crosslinking blocking agent may remain on the surface of the crosslinkable resin composition. The crosslinking blocking agent may also diffuse into the crosslinkable resin composition onto which it has been applied. It may further be worthwhile noting that the expression “mask pattern” should not be taken to imply that it comprises only areas without crosslinking blocking agent and areas with a uniform areal density of crosslinking blocking agent (binary mask pattern). While a binary mask pattern is an option, in general, the mask pattern may comprise gradients or graduations of the areal density of crosslinking blocking agent. The mask pattern may also comprise one or more crosslinking blocking agents in combination with one or more repelling agents. If the mask pattern comprises plural components, e.g., plural crosslinking blocking agents, plural repelling agents, or one or more crosslinking blocking agents in combination with one or more repelling agents, these may be applied via separate printheads, so that the areal densities of the different components may be varied relative to one another within the mask pattern. In this case, the mask pattern conceptually corresponds to the superposition of plural mask pattern channels.

After the layer of crosslinkable resin composition 38 carrying the mask pattern has at least partially been cured, uncured crosslinkable resin composition is removed. The removal may be effected by mechanical action, e.g., by blowing, brushing, and/or aspiration. In the embodiments of FIGS. 2 and 3, the removal is carried out using one of more brushes 48 which loosen the mask pattern and uncured resin residues by mechanical friction and one or more suction apparatuses 50. As an alternative to, or in addition to the one or more brushes 48, a blower (e.g., an air knife) could be used. The crosslinking blocking agent 42 may be removed together with the uncured crosslinkable resin composition. The removal of matter leaves a cross-linked polymer layer (like layer 22d in FIG. 1) with depressions and/or protrusions in its surface, which form the three-dimensional surface topography. The mask pattern is configured such that the resulting topography also comprises a ramp section 28 extending along an edge of the decorative surface covering panel in the making.

The digitally embossed layer is thereafter coated with a foremost layer of crosslinkable resin so as to form a topcoat 52. The coating may be effected by any suitable technique, e.g., by roller-coating 54 (as illustrated in FIGS. 2 and 3) or printing (e.g., digital printing), etc. The topcoat 52 is applied with a substantially uniform thickness so as to conformally cover the three-dimensional topography of the embossed layer including, in particular, the shoulder section thereof.

The topcoat 52 may comprise, e.g., a UV-curable topcoat, preferably a UV-curable PU topcoat. A matte surface finish may be obtained by generating a microfolded skin layer in the topcoat 52 by first exposing the topcoat to V-UV light (from V-UV light source 55) and then curing the topcoat in depth. In-depth curing of the topcoat may include irradiation with UV light of longer wavelengths (>200 nm), capable of penetrating further into the topcoat layer than the V-UV light, which is quickly absorbed in the superficial skin layer. The UV light of longer wavelengths may be provided by one or more UV lamps 56. The topcoat 52 is preferably comprised of one or more continuous layers, so as to completely seal off the underlying embossed layer.

FIG. 2 illustrates an embodiment of the method according to the disclosure adapted to precut substructure elements, which have the lateral dimensions of the decorative surface covering panels in the making. In contrast, FIG. 3 illustrates an embodiment of the method, wherein the substructure has at least one lateral dimension greater than the decorative surface covering panel in the making and wherein the method comprises a step of cutting the substructure in register with the embossed topography. The first steps of the process of FIG. 3 are the same as those of the process of FIG. 2. Turning specifically to FIG. 3, the core structure 18 is provided as a continuous web. After the printing of the decorative motif, the substructure 21 receives the layers of cross-linkable resin, the penultimate of which undergoes digital embossing. The digital embossing comprises forming ramps 28 (or other shoulders, such as, e.g., rounded shoulders or step-shaped shoulders) along predefined cutting lines corresponding to the lateral sides of the panels in the making. These cutting lines are in register with both the decorative motif and the embossed topography. Before or after the application of the topcoat 52 (FIG. 3 illustrates the latter case), the substructure and the layers applied thereon are cut along the cutting lines. The cutting may be carried out with a guillotine 58 and/or another cutting tool. For instance, a milling cutter may be used, especially if connecting profiles need be formed in the side surface(s) of the panels.

The embossing processes of the embodiments of the disclosure are preferably carried out in register with the decorative motif. This may be achieved by providing a relief file representing the three-dimensional surface structure to be imparted and an image file representing the decorative motif, both files corresponding to the same section (defined area) of the decorative surface covering. The embossing equipment and/or the digital printer of the decorative motif are adjusted in such a way that the intended spatial relationship between the three-dimensional surface structure and the decorative motif is achieved. When the digital printing and the digital embossing takes place on individual precut elements, such as, e.g., tile blanks or panel blanks or the like (as shown in FIG. 2), the individual elements may be detected (optically or otherwise) when they arrive at the printing stage and/or the embossing stage, so that the printed decorative motif and the embossing can be precisely aligned with each individual element.

Optionally, misalignments may be monitored and corrected dynamically. To achieve this, registration marks can be applied on the printing substrate when the two-dimensional decorative motif is printed. The registration marks may be part of the two-dimensional decorative motif if its design permits. These registration marks can then be used in the production stages downstream, in particular in the digital embossing stage. For instance, the digital embossing stage could comprise one or more optical sensors (e.g., digital cameras), arranged in known spatial relationship to one or more of the digital printers of the embossing stage, for detecting the position and, optionally, the velocity, of the registration marks and thus of the two-dimensional decorative motif at a certain time. The position (and velocity) information provided by the one or more optical sensors may be used by a controller of the embossing stage to adjust the position of the embossed motif to the position of the two-dimensional decorative motif. It may be worthwhile noting that the dynamic monitoring and correction of misalignments using registration marks may be useful when the substrate is a continuous web (in contrast to individual elements).

With reference to FIGS. 1 to 3, the decorative surface covering being produced may be PVC-free. The one or more core layers may comprise or consist of one or more crosslinked-polymer (e.g. thermoset) layers, one or more thermoplastic layer, e.g., based on PVB (polyvinyl butyral), polyethylene terephthalate, or polypropylene. The one or more core layers may also be PVC-based.

The crosslinkable resin composition(s) may, e.g., comprise urethane acrylate, polyurethane acrylate, epoxy acrylate, polyester acrylate, polyether acrylate or polyether urethane acrylate. The one or more crosslinkable resin compositions are preferably UV curable. It should be noted that the various layers having a crosslinkable resin composition may have the same or different composition. In the cured state, the foremost layer, i.e., the topcoat, preferably comprises polyurethane.

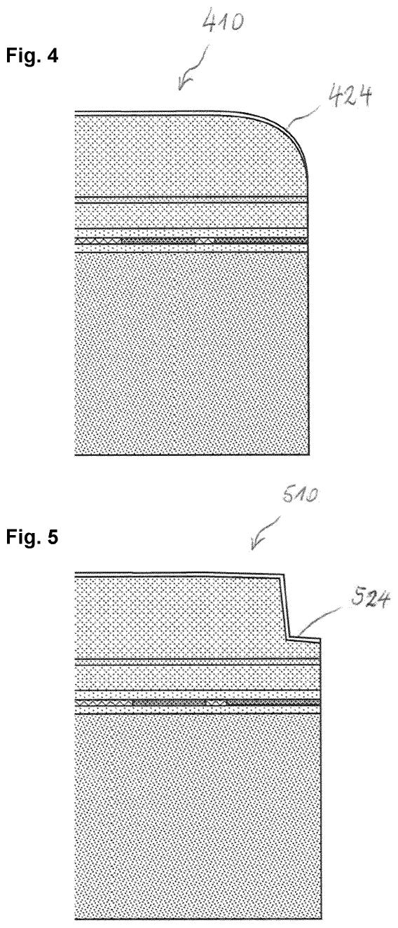

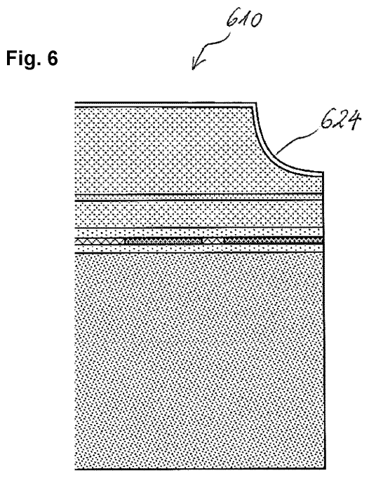

FIGS. 4-6 illustrate further embodiments of the transitional edge surface. The surface covering panels of these drawings have the same layer structure as the panel illustrated in FIG. 1, which will not, therefore, be explained again. FIG. 4 shows a decorative surface covering panel 410 having a transitional edge surface 424 in the form of a convex rounded shoulder. FIG. 6 shows a decorative surface covering panel 610 having a transitional edge surface 624 in the form of a concave rounded shoulder. FIG. 5 shows a decorative surface covering panel 510 having a transitional edge surface 524 in the form of a step-shaped shoulder. In each case, the profile of the transitional edge surface is defined by the shoulder section of the three-dimensional topography of the embossed layer.

While specific embodiments have been described herein in detail, those skilled in the art will appreciate that various modifications and alternatives to those details could be developed in light of the overall teachings of the disclosure. Accordingly, the particular arrangements disclosed are meant to be illustrative only and not limiting as to the scope of the disclosure, which is to be given the full breadth of the appended claims and any and all equivalents thereof.

1. A decorative surface covering panel, having
a front surface, a rear surface and one or more side surfaces extending around the decorative surface covering panel;
a layered structure comprising, in this order from the rear surface to the front surface: one or more core layers, a décor layer supported by the one or more core layers, and a transparent or translucent surface layer stack covering the décor layer;
wherein the surface layer stack comprises at least two crosslinked-polymer layers, the at least two crosslinked-polymer layers including a foremost crosslinked-polymer layer and at least one further crosslinked-polymer layer, the foremost crosslinked-polymer layer providing the front surface;
wherein each one of the one or more side surfaces has a frontward portion and a rearward portion separated from each other at the height of the décor layer, the frontward portion closer to the front surface and the rearward portion farther away from the front surface;
wherein the decorative surface covering panel has at least one transitional edge surface extending from the front surface to one of the one or more side surfaces;
wherein the at least one transitional edge surface touches the one of the one or more side surfaces along a boundary line recessed from the front surface;
wherein the boundary line is located in the frontward portion of the one of the one or more side surfaces;
wherein the foremost crosslinked-polymer layer and at least one further crosslinked-polymer layer of the surface layer stack extend to the frontward portion of the one of the one or more side surfaces, between the décor layer and the boundary line;
wherein the at least one further crosslinked-polymer layer of the surface layer stack that extends to the frontward portion of the one of the one or more side surfaces has a topography including a shoulder section underlying the at least one transitional edge surface and defining the profile of the transitional edge surface; and
wherein the foremost crosslinked-polymer layer forms a topcoat on the at least one further crosslinked-polymer layer conformally covering the topography of the at least one further crosslinked-polymer layer including the shoulder section thereof.

2. The decorative surface covering panel as claimed in claim 1, wherein the at least two crosslinked-polymer layers comprise at least one of polyurethane, polyurethane acrylate, epoxy acrylate, polyester acrylate, polyether acrylate and polyether urethane acrylate.

3. The decorative surface covering panel as claimed in claim 1,
wherein the decorative surface covering panel has plural side surfaces and plural transitional edge surfaces, each transitional edge surface extending from the front surface to a respective one of the side surfaces,
wherein each transitional edge surface touches the respective side surface along a boundary line recessed from the front surface;
wherein the boundary line is located in the frontward portion of the respective side surface;
wherein the foremost crosslinked-polymer layer and at least one further crosslinked-polymer layer of the surface layer stack extend to the frontward portion of each one of the side surfaces, between the décor layer and the boundary line;
wherein the topography of the at least one further crosslinked-polymer layer of the surface layer stack includes plural shoulder sections, each shoulder section underlying a respective transitional edge surface and defining the profile of the respective transitional edge surface; and
wherein the foremost crosslinked-polymer layer conformally covers the topography of the at least one further crosslinked-polymer layer including the plural shoulder sections thereof.

4. The decorative surface covering panel as claimed in claim 1, wherein the foremost crosslinked-polymer layer has a uniform thickness all over the front surface and the transitional edge surface(s).

5. The decorative surface covering panel as claimed in claim 1, wherein the décor layer comprises a digitally printed two-dimensional decorative motif, and wherein the topography of the at least one further crosslinked-polymer layer is in register with the decorative motif.

6. The decorative surface covering panel as claimed in claim 1, wherein the foremost crosslinked-polymer layer is made from polyurethane.

7. The decorative surface covering panel as claimed in claim 1, wherein the foremost crosslinked-polymer layer has a thickness that amounts to 15% or less, preferably to 10% or less than, of the overall thickness of the at least one further crosslinked-polymer layer of the surface layer stack.

8. The decorative surface covering panel as claimed in claim 1, wherein the foremost crosslinked-polymer layer comprises a microfolded skin layer.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. The decorative flooring panel as claimed in claim 1, wherein the foremost crosslinked-polymer layer is made from polyurethane and wherein the foremost crosslinked-polymer layer has a thickness that amounts to 15% or less of the overall thickness of the at least one further crosslinked-polymer layer of the surface layer stack.

24. The decorative flooring panel as claimed in claim 23, wherein the foremost crosslinked-polymer layer comprises a microfolded skin layer.

25. A decorative flooring panel, having
a front surface, a rear surface and plural side surfaces extending around the decorative flooring panel;
a layered structure comprising, in this order from the rear surface to the front surface: one or more core layers, a décor layer supported by the one or more core layers, and a transparent or translucent surface layer stack covering the décor layer;
wherein the surface layer stack comprises at least two crosslinked-polymer layers, the at least two crosslinked-polymer layers including a foremost crosslinked-polymer layer and at least one further crosslinked-polymer layer, the foremost crosslinked-polymer layer providing the front surface;
wherein each one of the side surfaces has a frontward portion and a rearward portion separated from each other at the décor layer, the frontward portion closer to the front surface and the rearward portion farther away from the front surface;
wherein the decorative flooring panel has plural transitional edge surfaces, each transitional edge surface extending from the front surface to a respective one of the side surfaces,
wherein each transitional edge surface touches the respective side surface along a boundary line recessed from the front surface;
wherein the boundary line is located in the frontward portion of the respective side surface;
wherein the foremost crosslinked-polymer layer and at least one further crosslinked-polymer layer of the surface layer stack extend to the frontward portion of each one of the side surfaces, between the décor layer and the boundary line;
wherein the at least one further crosslinked-polymer layer of the surface layer stack that extends to the frontward portion of the one of the side surfaces has a topography that includes plural shoulder sections, each shoulder section underlying a respective transitional edge surface and defining the profile of the respective transitional edge surface;
wherein the foremost crosslinked-polymer layer forms a topcoat on the at least one further crosslinked-polymer layer;
wherein the foremost crosslinked-polymer layer conformally covers the topography of the at least one further crosslinked-polymer layer including the plural shoulder sections thereof;
and wherein the foremost crosslinked-polymer layer has a substantially uniform thickness all over the front surface and the transitional edge surfaces.

26. The decorative flooring panel as claimed in claim 25, wherein the at least two crosslinked-polymer layers comprise at least one of polyurethane, polyurethane acrylate. epoxy acrylate, polyester acrylate, polyether acrylate and polyether urethane acrylate.

27. The decorative flooring panel as claimed in claim 25, wherein the décor layer comprises a digitally printed two-dimensional decorative motif, and wherein the topography of the at least one further crosslinked-polymer layer is in register with the decorative motif.

28. The decorative flooring panel as claimed in claim 25, wherein the foremost crosslinked-polymer layer is made from polyurethane.

29. The decorative flooring panel as claimed in claim 25, wherein the foremost crosslinked-polymer layer has a thickness that amounts to 15% or less of the overall thickness of the at least one further crosslinked-polymer layer of the surface layer stack.

30. The decorative flooring panel as claimed in claim 25, wherein the foremost crosslinked-polymer layer comprises a microfolded skin layer.
